(19) United States
(12) Patent Application Publication
(10) Pub. No.: US 2023/0079478 A1
(43) Pub. Date: Mar. 16, 2023

(54) FACE MESH DEFORMATION WITH DETAILED WRINKLES

(71) Applicant: SOUL MACHINES, Auckland (NZ)

(72) Inventors: Colin HODGES, Auckland (NZ); David GOULD, Dunedin (NZ); Mark SAGAR, Auckland (NZ); Tim WU, Auckland (NZ); Sibylle VAN HOVE, Auckland (NZ); Alireza NEJATI, Auckland (NZ); Werner OLLEWAGEN, Auckland (NZ); Xueyuan ZHANG, Auckland (NZ)

(21) Appl. No.: 17/801,716

(22) PCT Filed: Feb. 10, 2021
(86) PCT No.: PCT/IB2021/051051

§ 371 Date: Aug. 23, 2022

(30) Foreign Application Priority Data
Feb. 26, 2020 (NZ) 762119

(51) Int. Cl. G06T 19/20; G06T 17/20

(52) U.S. Cl. CPC G06T 19/20; G06T 17/20; G06T 2219/2021

(57) ABSTRACT

Methods and systems describe providing face mesh deformation with detailed wrinkles. A neutral mesh based on a scan of a face is provided along with initial control point positions on the neutral mesh and user-defined control point positions corresponding to a non-neutral facial expression. A radial basis function (RBF) deformed mesh is generated based on RBF interpolation of the initial control point positions and the user-defined control point positions. Predicted wrinkle deformation data is then generated by one or more cascaded regressors networks. Finally, a final deformed mesh is provided with wrinkles based on the predicted wrinkle deformation data.

### FIELD OF THE INVENTION

The present invention relates generally to computer graphics, and more particularly, to methods and apparatuses for providing face mesh deformation with detailed wrinkles.

### BACKGROUND

Within the fields of computer graphics and computer animation, a burgeoning area of interest is the creation of realistic, life-like digital avatars, digital actors, and digital representations of real humans (collectively referred to hereinafter as “digital avatars” or “digital humans”). Such avatars are in high demand within the movie and video game industries, among others. This interest has increased in recent years as the technology has allowed such digital avatars to be produced on a wider scale, with less time, effort, and processing costs involved.

While such experiences have been established and possible for consumers for years, challenges remain in bringing these costs down to the point where digital avatars can be produced on a mass scale with a minimum amount of manual effort from sculpting artists. A typical approach is for hundreds of scans to be taken of a person, and then from those scans a mesh topology with face meshes for each scan can be made. Each face mesh typically requires a team of artists to sculpt the mesh to correct for a number of errors and inaccuracies resulting from misplaced, absent, or unnecessary control points on the face mesh. The face meshes can then be adapted for use in games and movies after adding textures and features (e.g., skin, lips, hair) as needed.

The problem with this approach, however, is that it is quite time-consuming. Even if the scanning portion is relatively inexpensive, several digital artists are often required to clean up the scan data, as it is regularly filled with inaccuracies and artifacting which carry over to the meshes produced. In addition, there is increasing demand to not make simply one digital human as the end result, but to potentially make a template for dozens or hundreds of potential digital humans. It is hard to be consistent with similar qualities, expressions, and gestures across different avatars using the existing methods.

A popular way to standardize the different avatars is the Facial Coding Action System (FACS), which allows for fixed facial expressions and elementary movements of the face. With FACS, however, a potentially large management task is created in standardizing expressions and faces across all the avatars. The amount of variations in human faces leads to difficulties in differentiating anatomical features in underlying bone structure. With FACS, the goal is to only describe the physiological movement rather than the unique bone and tissue structure (i.e., the unique facial identity) of the person, in order to enable unique faces to all have the same expression. However, for each facial expression for a face, there are not just muscle contractions, but particular ways in which facial muscles slide over an underlying bone structure of the face. One major area in which inaccuracies form based on FACS standardization is in capturing the way wrinkles and skin folds appear on a face based on changing facial expressions. Therefore, digital artists are required to adapt these physiological movements to the unique ways the movements manifest based on bone structure, to include detailed wrinkles and skin folds for different faces across standardized facial expressions.

Thus, there is a need in the field of computer graphics to create a new and useful system and method for providing realistically deformed facial meshes with detailed wrinkles and skin folds. The source of the problem, as discovered by the inventors, is a lack of accurate automated methods to capture deformations in facial expressions in a detailed way.

### SUMMARY OF THE INVENTION

One embodiment relates to providing face mesh deformation with detailed wrinkles. The system receives a neutral mesh based on a scan of a face, and initial control point positions on the neutral mesh. The system also receives a number of user-defined control point positions corresponding to a non-neutral facial expression. The system first generates a radial basis function (RBF) deformed mesh based on RBF interpolation of the initial control point positions and the user-defined control point positions. The system then generates predicted wrinkle deformation data based on the RBF deformed mesh and the user-defined control points, with the predicted wrinkle deformation data being generated by one or more cascaded regressors networks. Finally, the system provides, for display on a client device within a user interface, a final deformed mesh with wrinkles based on the predicted wrinkle deformation data.

Another embodiment relates to computing diffusion flows representing the Gaussian kernel of the geodesic distance between the initial control point positions and all other vertices in the neutral mesh, and then determining the RBF interpolation of the initial control point positions and the user-defined control point positions based on the computed diffusion flows.

Another embodiment relates to segmenting each of a number of example RBF deformed meshes into a number of unique facial regions, and then training a cascaded regressors network on each unique facial region of the example RBF deformed meshes. These trained regressors networks are then used to generate the predicted wrinkle deformation data based on the RBF deformed mesh and the user-defined control points.

Another embodiment relates to predicting initial vertices displacement data using a displacement regressor as part of each of one or more cascaded regressors networks. The system then provides, for display on a client device within a user interface, a preview deformed mesh with wrinkles based on the predicted initial vertices displacement data. The system then predicts deformation gradient tensors using a deformation gradient regressor as part of each of the one or more cascaded regressors networks.

The features and components of these embodiments will be described in further detail in the description which follows. Additional features and advantages will also be set forth in the description which follows, and in part will be implicit from the description, or may be learned by the practice of the embodiments.

### BRIEF DESCRIPTION OF THE DRAWINGS

FIG. 1A is a diagram illustrating an exemplary environment in which some embodiments may operate.

FIG. 1B is a diagram illustrating an exemplary computer system that may execute instructions to perform some of the methods herein.

FIG. 2A is a flow chart illustrating an exemplary method that may be performed in some embodiments.

FIG. 2B is a flow chart illustrating additional steps that may be performed in accordance with some embodiments.

FIG. 2C is a flow chart illustrating additional steps that may be performed in accordance with some embodiments.

FIG. 2D is a flow chart illustrating additional steps that may be performed in accordance with some embodiments.

FIG. 3A is a diagram illustrating one example embodiment of a process for training cascaded regressors networks in accordance with some of the systems and methods herein.

FIG. 3B is a diagram illustrating one example embodiment of a process for providing face deformation with detailed wrinkles in accordance with some of the systems and methods herein.

FIG. 3C is a diagram illustrating one example embodiment of a process for providing visual feedback guidance for mesh sculpting artists in accordance with some of the systems and methods herein.

FIG. 4A is an image illustrating one example of a neutral mesh with initial control point positions in accordance with some of the systems and methods herein.

FIG. 4B is an image illustrating one example of a neutral mesh with radius indicators in accordance with some of the systems and methods herein.

FIG. 4C is an image illustrating one example of a process for generating a radial basis function (RBF) deformed mesh based on RBF interpolation in accordance with some of the systems and methods herein.

FIG. 4D is an image illustrating an additional example of a process for generating an RBF deformed mesh based on RBF interpolation in accordance with some of the systems and methods herein.

FIG. 4E is an image illustrating one example of computed diffusion flows in accordance with some of the systems and methods herein.

FIG. 4F is an image illustrating one example of a process for providing spline interpolation in accordance with some of the systems and methods herein.

FIG. 4G is an image illustrating an additional example of a process for providing spline interpolation in accordance with some of the systems and methods herein.

FIG. 4H is an image illustrating one example of a process for providing visual feedback guidance in accordance with some of the systems and methods herein.

FIG. 4I is an image illustrating one example of a process for providing segmented masks in accordance with some of the systems and methods herein.

FIG. 4J is an image illustrating an additional example of a process for providing segmented masks in accordance with some of the systems and methods herein.

FIG. 5 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments relate to providing face mesh deformation with detailed wrinkles. “Face mesh” as used herein shall be understood to contemplate a variety of computer graphics and computer animation meshes pertaining to digital avatars, including, e.g., meshes relating to faces, heads, bodies, body parts, objects, anatomy, textures, texture overlays, and any other suitable mesh component or element. “Deformation” as used herein shall be understood to contemplate a variety of deformations and changes to a mesh, including deformations caused as a result of a facial expression, gesture, movement, effect of some outside force or body, anatomical change, or any other suitable deformation or change to a mesh. “Detailed wrinkles” and “wrinkles” as used herein shall be understood to contemplate a variety of wrinkles, skin folds, creases, ridges, lines, dents, and other interruptions of otherwise smooth or semi-smooth surfaces. Typical examples include wrinkles or skin folds from, e.g., aging, as well as dimples, eye crinkles, wrinkles in facial skin commonly caused by facial expressions which stretch or otherwise move the skin in various ways, wrinkles on the skin caused by exposure to water, and “laugh lines”, i.e., lines or wrinkles around the outer corners of the mouth and eyes typically caused by smiling or laughing. Many other such possibilities can be contemplated.

### I. Exemplary Environments

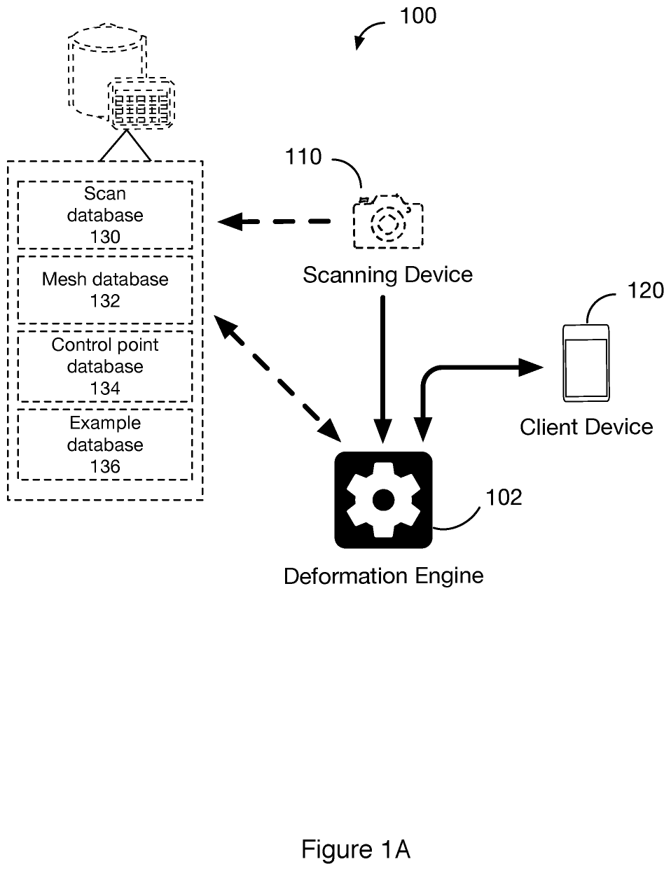

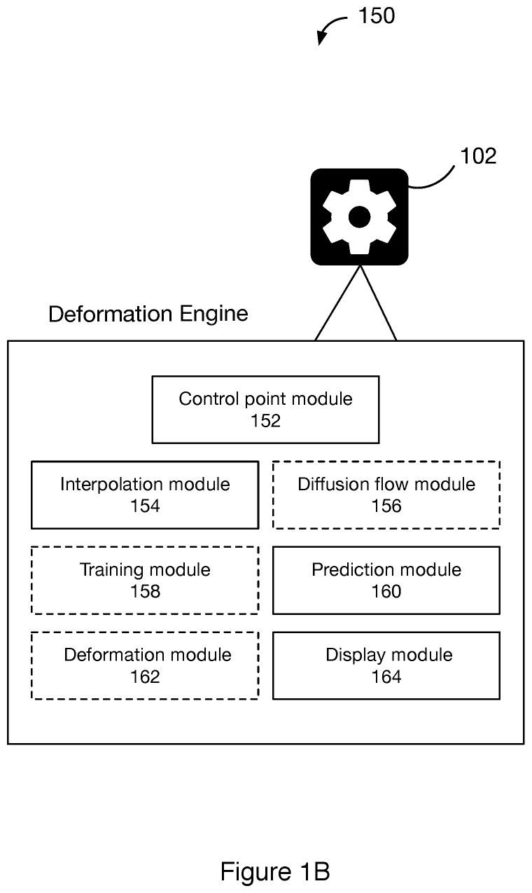

FIG. 1A is a diagram illustrating an exemplary environment in which some embodiments may operate. In the exemplary environment 100, a client device 120 and an optional scanning device 110 are connected to a deformation engine 102. The deformation engine 102 and optional scanning device 110 are optionally connected to one or more optional database(s), including a scan database 130, mesh database 132, control point database 134, and/or example database 136. One or more of the databases may be combined or split into multiple databases. The scanning device and client device in this environment may be computers.

The exemplary environment 100 is illustrated with only one scanning device, client device, and deformation engine for simplicity, though in practice there may be more or fewer scanning devices, client devices, and/or deformation engines. In some embodiments, the scanning device and client device may communicate with each other as well as the deformation engine. In some embodiments, one or more of the scanning device, client device, and deformation engine may be part of the same computer or device.

In an embodiment, the deformation engine 102 may perform the method 200 or other method herein and, as a result, provide mesh deformation with detailed wrinkles. In some embodiments, this may be accomplished via communication with the client device or other device(s) over a network between the client device 120 or other device(s) and an application server or some other network server. In some embodiments, the deformation engine 102 is an application hosted on a computer or similar device, or is itself a computer or similar device configured to host an application to perform some of the methods and embodiments herein.

Scanning device 110 is a device for capturing scanned image data from an actor or other human. In some embodiments, the scanning device may be a camera, computer, smartphone, scanner, or similar device. In some embodiments, the scanning device hosts an application configured to perform or facilitate performance of generating three-dimensional (hereinafter “3D”) scans of human subjects, and/or is communicable with a device hosting such an application. In some embodiments, the process may include 3D imaging, scanning, reconstruction, modeling, and any other suitable or necessary technique for generating the scans. The scanning device functions to capture 3D images of humans, including 3D face scans. In some embodiments, the scanning device 110 send the scanned image and associated scan data to optional scan database 130. The scanning device 110 also sends the scanned image and associated scan data to deformation engine 102 for processing and analysis. In some embodiments, the scanning device may use various techniques including photogrammetry, tomography, light detection and ranging (LIDAR), infrared or structured light, or any other suitable technique. In some embodiments, the scanning device includes or is communicable with a number of sensors, cameras, accelerometers, gyroscopes, inertial measurement units (IMUs), and/or other components or devices necessary to perform the scanning process. In some embodiments, metadata associated with the scan is additionally generated, such as 3D coordinate data, six axis data, point cloud data, and/or any other suitable data.

Client device 120 is a device that sends and receives information to the deformation engine 102. In some embodiments, client device 120 is a computing device capable of hosting and executing an application which provides a user interface for digital artists, such as sculpting artists within computer graphics and computer animation contexts. In some embodiments, the client device 120 may be a computer desktop or laptop, mobile phone, virtual reality or augmented reality device, wearable, or any other suitable device capable of sending and receiving information. In some embodiments, the deformation engine 102 may be hosted in whole or in part as an application executed on the client device 120.

Optional database(s) including one or more of a scan database 130, mesh database 132, control point database 134, and example database 136 function to store and/or maintain, respectively, scanned images and scan metadata; meshes and mesh metadata; control points and control point metadata, including control point position data; and example data and metadata, including, e.g., example meshes, segmentation masks, and/or deformed examples. The optional database(s) may also store and/or maintain any other suitable information for the deformation engine 102 to perform elements of the methods and systems herein. In some embodiments, the optional database(s) can be queried by one or more components of system 100 (e.g., by the deformation engine 102), and specific stored data in the database(s) can be retrieved.

FIG. 1B is a diagram illustrating an exemplary computer system 150 with software modules that may execute some of the functionality described herein.

Control point module 152 functions to receive a neutral mesh and initial control point positions, as well as to receive user-defined control point positions. In some embodiments, the control point module 152 retrieves the above from one or more databases, such as, e.g., the optional control point database 134 and/or the mesh database 132. In some embodiments, control point module 152 may additional store control point information, such as updated control point positions, in one or more databases such as the control point database 134.

Interpolation module 154 functions to generate radial basis function deformed meshes based on radial basis function interpolation of initial control point positions and user-defined control point positions. In some embodiments, the interpolation is based on the interpolation module 154 computing one or more distances between the initial control point positions and user-defined control point positions. In some embodiments, the distances are represented as the Gaussian kernel of the geodesic distance between the initial control point positions and all other vertices in the neutral mesh.

Optional diffusion flow module 156 functions to compute diffusion flows representing the Gaussian kernel of the geodesic distance between initial control point positions and all other vertices in the neutral mesh.

Optional training module 158 functions to train one or more cascaded regressors networks. In some embodiments, the training module 158 receives training data in the form of, e.g., example meshes, radial basis function deformed meshes, and segmentation masks, and uses the training data as inputs for one or more regressors to train the regressors to perform various tasks, including outputting predicted data.

Prediction module 160 functions to generate predicted data to output from one or more cascaded regressors networks. In some embodiments, prediction module 160 may output one or more of predicted wrinkle data, predicted initial vertices displacement, predicted deformation gradient tensors, or any other suitable predicted or preview data within the system.

Optional deformation module 162 functions to generate deformed meshes in the system. In some embodiments, the deformation module 162 generates a final deformed mesh to be displayed in a user interface for a user (e.g., a sculpting artist) to adapt for various uses. In some embodiments, the deformation module 162 generates a preview deformed mesh to be displayed in a user interface for a user to have a preview version of a deformed mesh which can be generated quickly (such as in real time or substantially real time) prior to a final deformed mesh being generated.

Display module 164 functions to display one or more outputted elements within a user interface of a client device. In some embodiments, the display module 164 can display a final deformed mesh within the user interface. In some embodiments, the display module 165 can display a preview deformed mesh within the user interface. In some embodiments, display module 164 can display one or more additional pieces of data or interactive elements within the user interface as is suitable or needed based on the systems and methods herein.

The above modules and their functions will be described in further detail in relation to an exemplary method below.

### II. Exemplary Method

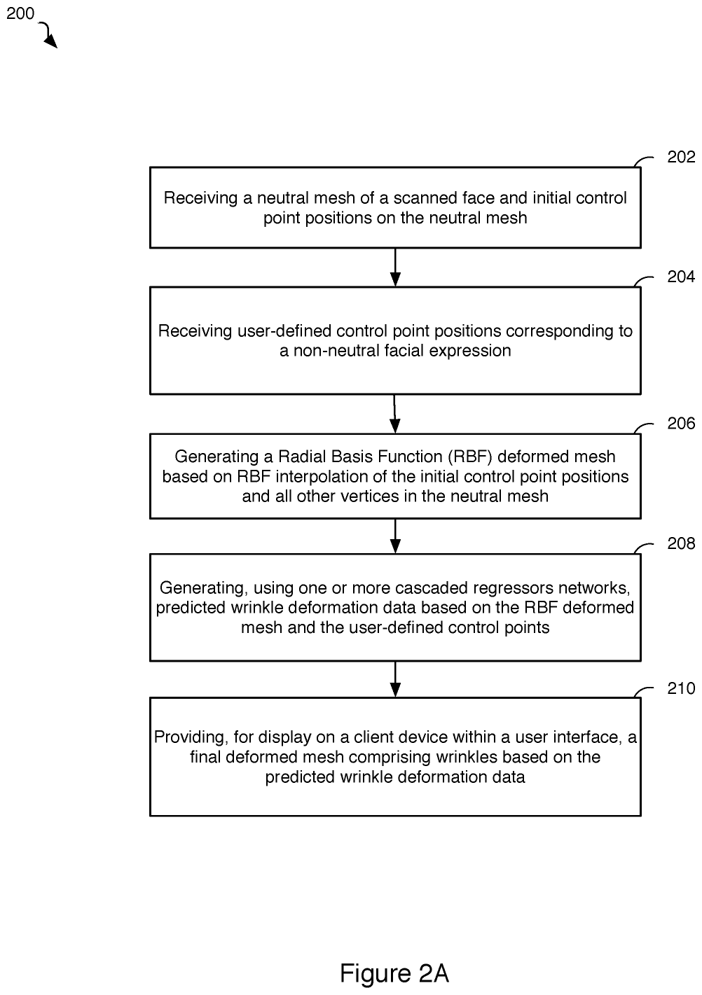

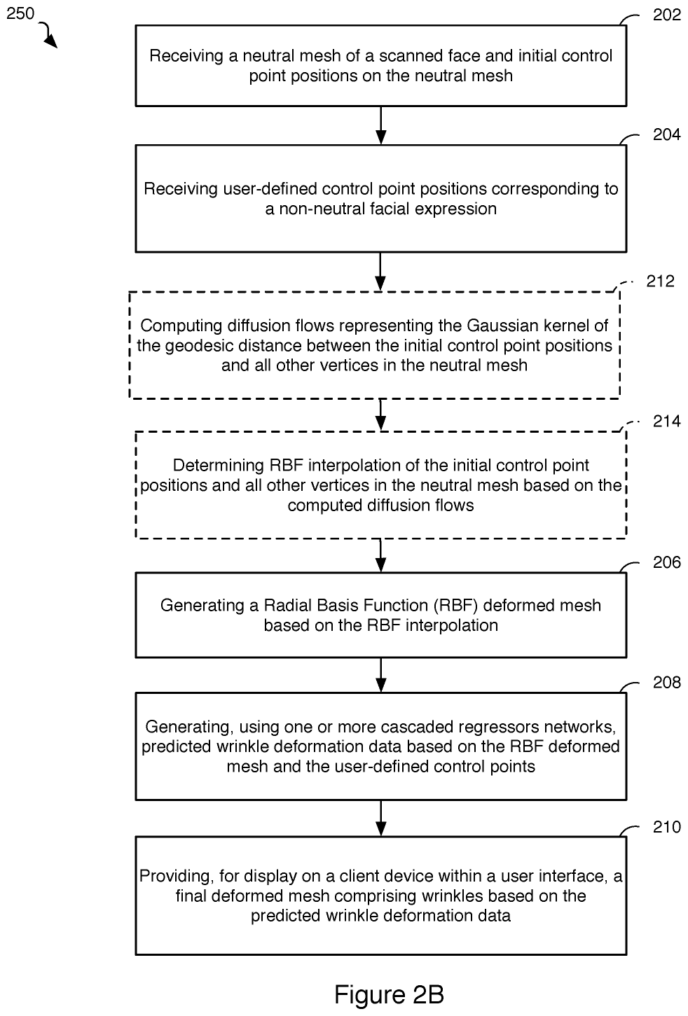

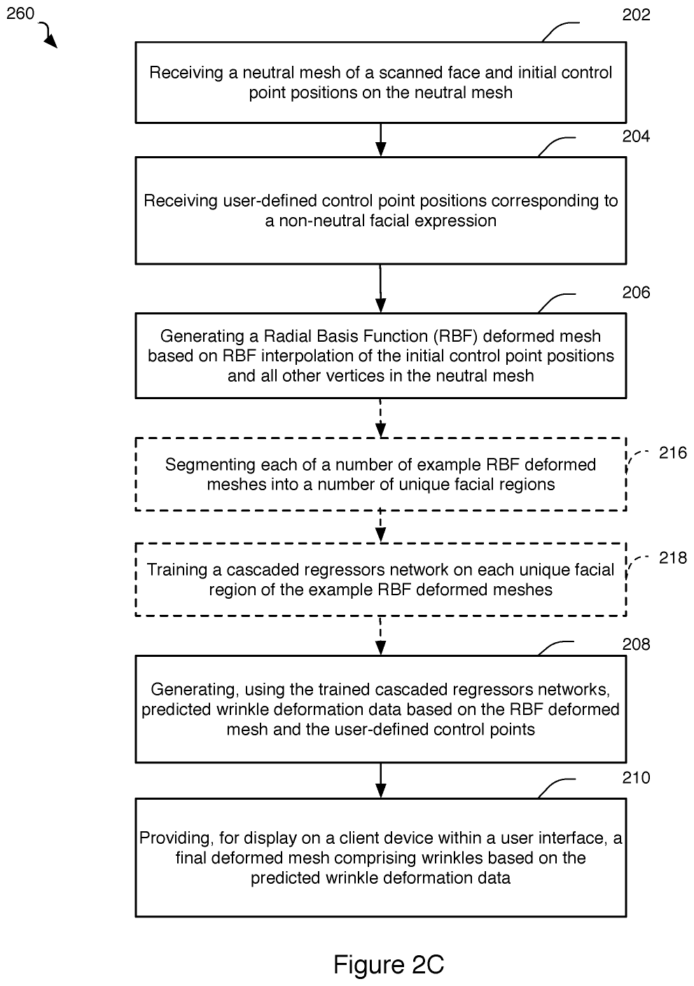

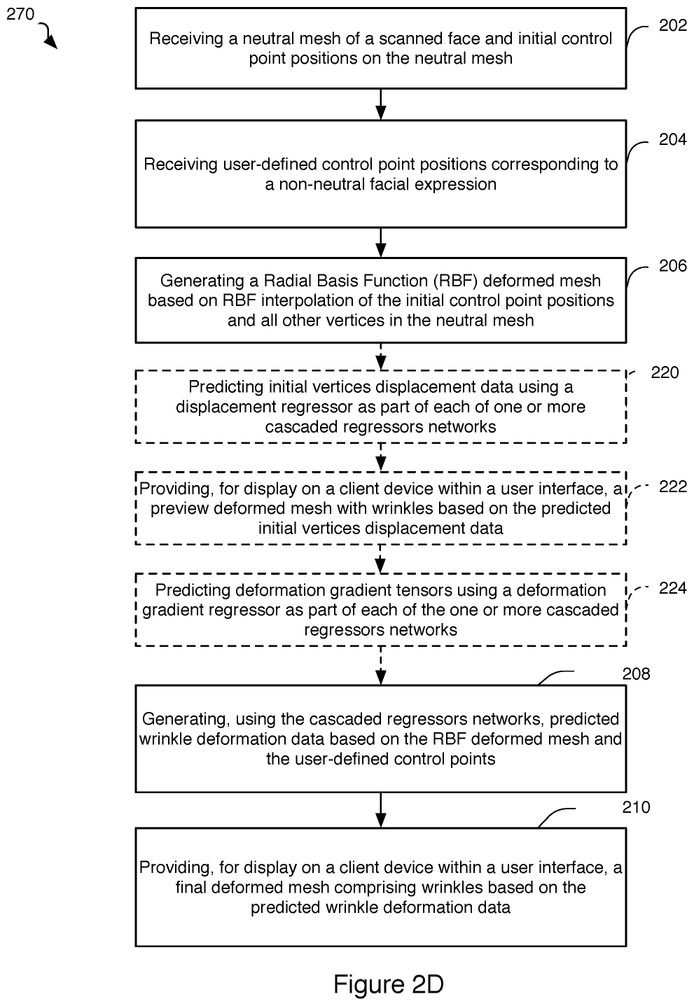

FIG. 2A is a flow chart illustrating an exemplary method that may be performed in some embodiments.

At step 202, the system receives a neutral mesh based on a scan of a face, as well as initial control point positions on the neutral mesh. In some embodiments, a scanning device 110 can generate scanned images of a face of an actor or other scanning subject, then send the generated scan images to one or more other elements of the system, such as the deformation engine 102 or scan database 130. In some embodiments, the scans are stored on the client device 120 and a neutral mesh is generated manually by a user, automatically, or semi-automatically based on the scan images. The neutral mesh is a three-dimensional mesh of a scanned image of the actor's face with a neutral facial expression, for use in computer graphics and computer animation tools to build and/or animate three-dimensional objects. In some embodiments, initial control point positions are generated as part of the process of generating the neutral mesh. The initial control point positions are selected positions in three-dimensional space which lie on the surface of the face mesh. The initial control point positions collectively designate distinguishing or important points of interest on the face with respect to controlling, deforming, or otherwise modifying the face and facial expressions. This neutral mesh and the initial control point positions are then sent to one or more elements of the system, such as the deformation engine 102, control point database 134, or mesh database 132.

At step 204, the system also receives a number of user-defined control point positions corresponding to a non-neutral facial expression. In some embodiments, the user-defined control point positions are generated by a user selecting or approving one or more control point positions at the client device. In some embodiments, the user-defined control point positions are generated by the user moving or adjusting one or more of the initial control point positions to form a non-neutral facial expression (e.g., a happy expression, sad expression, or any other expression other than the base neutral expression of the neutral mesh). In some embodiments, the control point positions are based on a scanned image of a non-neutral facial expression of the same face as the one the neutral mesh is based on. The user-defined control point positions represent important or distinguishing features of the non-neutral facial expression. In some embodiments, one or more of the user-defined control points are generated automatically and approved by the user. In some embodiments, one or more of the user-defined control points are created by the user at the user interface. In some embodiments, one or more of the user-defined control points are automatically generated at the user interface and then adjusted by the user at the user interface. The user-defined control points are then sent to one or more elements of the system, such as the deformation engine 102 and/or control point database 134.

At step 206, the system generates a radial basis function (hereinafter “RBF”) deformed mesh based on RBF interpolation of the initial control point positions and the user-defined control point positions. RBF interpolation as used herein refers to constructing a new mesh deformation by using radial basis function networks. In one example embodiment, given a set of initial control points as above, the user or artist moves (or approves moving) one or more of these initial control points as desired to produce a set of user-defined control points. The resulting deformation of the mesh is then interpolated to the rest of the mesh.

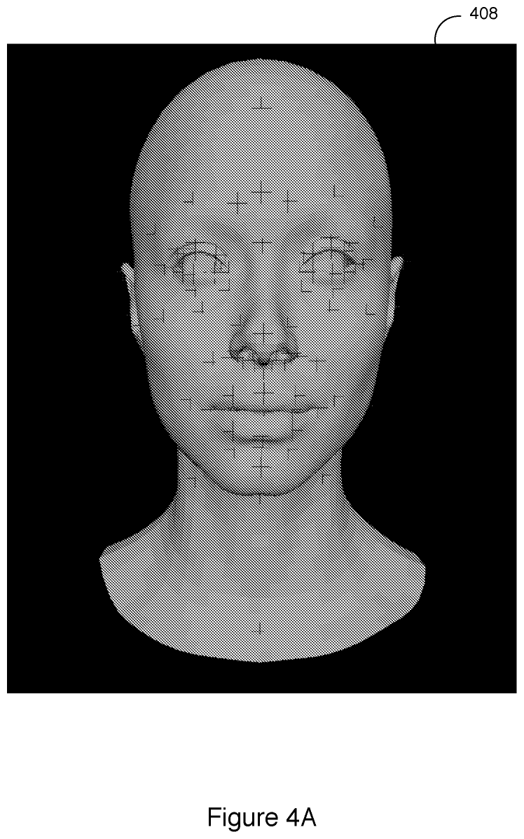

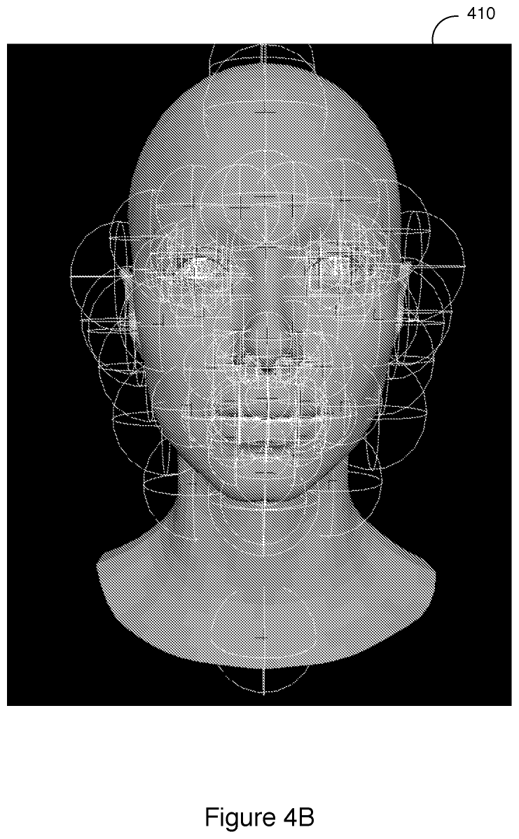

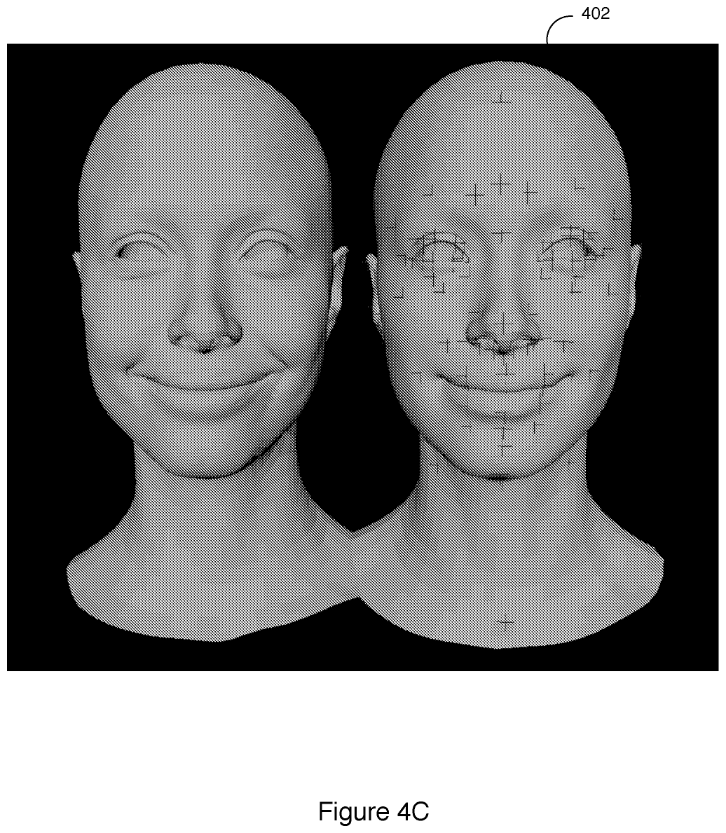

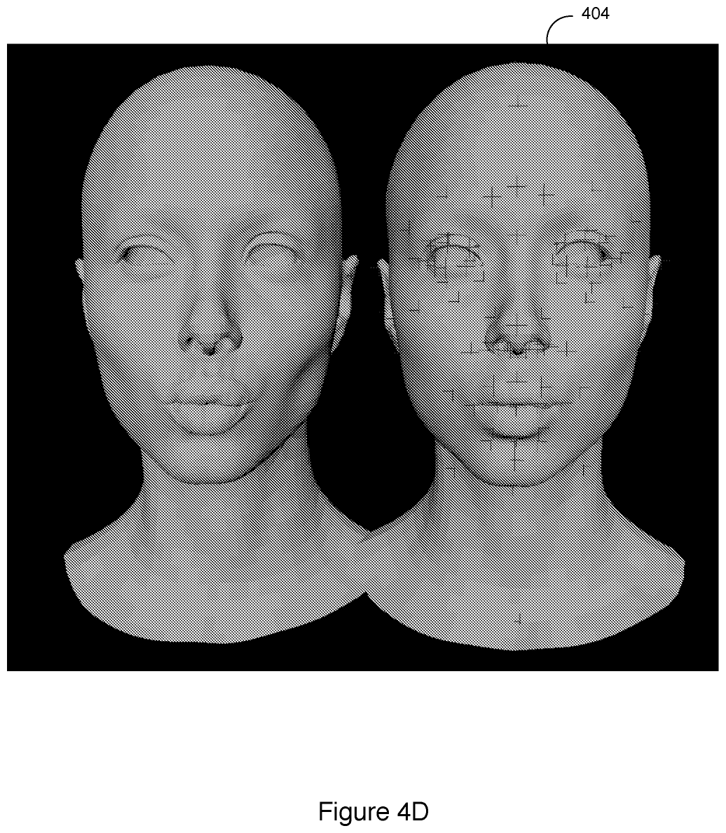

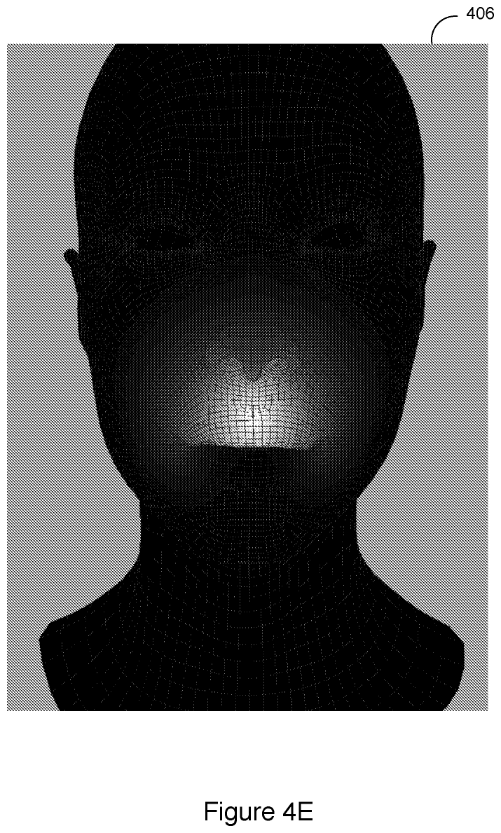

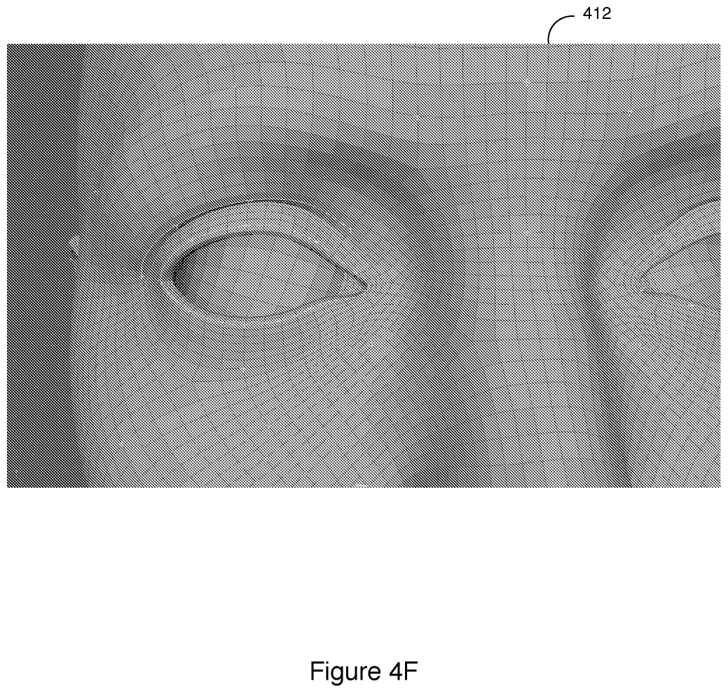

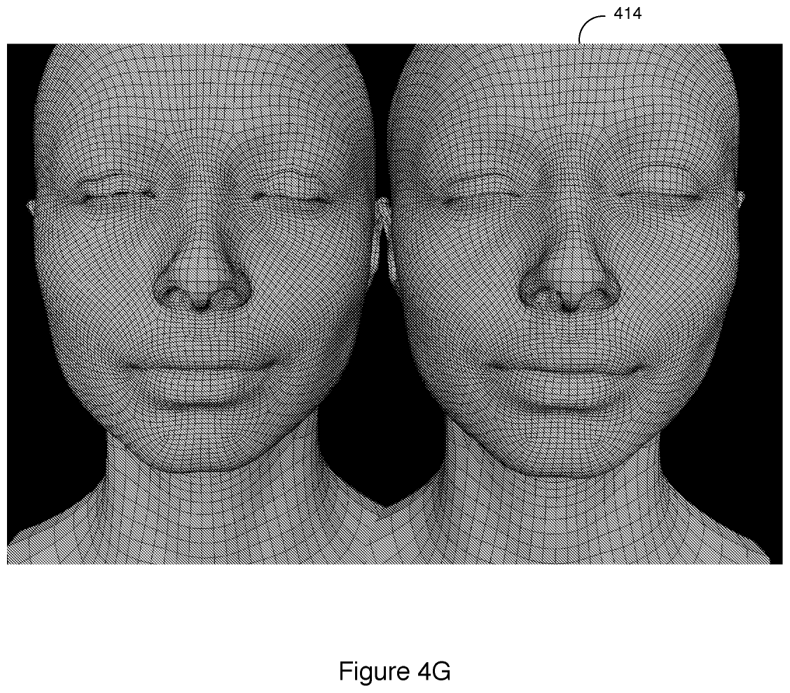

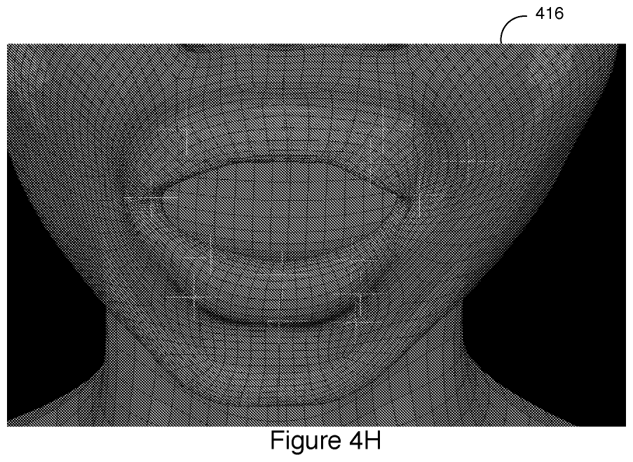

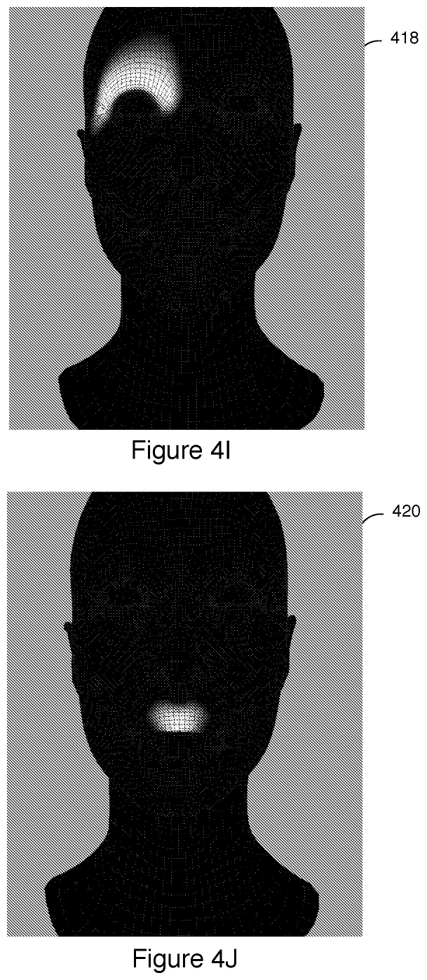

FIG. 4A is an image illustrating one example of a neutral mesh with initial control point positions in accordance with some of the systems and methods herein. The image shows a 3D face mesh with a neutral expression, scanned from an actor. Several initial control point positions have been generated and overlaid on the surface of the face mesh. The initial control point positions have either been generated manually, automatically, or some combination of both.

FIG. 4B is an image illustrating one example of a neutral mesh with radius indicators in accordance with some of the systems and methods herein. In some embodiments, the radius indicators can be overlaid on top of the control point positions of the mesh shown in FIG. 4A. The radius indicators provide a small radius for each control point position which can be useful visual guidance for artists sculpting and adjusting control points on the mesh.

FIG. 4C is an image illustrating one example of a process for generating a radial basis function (RBF) deformed mesh based on RBF interpolation in accordance with some of the systems and methods herein. In the image, the face mesh on the left is a scanned image of a target face. The face mesh on the right is an RBF deformed face mesh, wherein the control markers are adjusted by moving them to the positions represented by the scanned target face. The rest of the mesh vertices are interpolated and predicted using the RBF deformer. The mesh on the left contains more wrinkles than the mesh on the right as a result of the RBF deformer creating a smooth interpolation in the areas between the control markers, hence resulting in an interpolation without wrinkles.

FIG. 4D is an image illustrating an additional example of a process for generating a radial basis function (RBF) deformed mesh based on RBF interpolation in accordance with some of the systems and methods herein. The image is similar to FIG. 4C, but with a different expression. The RBF deformer creates a smooth interpolation in the areas between the control markers in order to correct some aspects of the lips.

In some embodiments, RBF interpolation involves using a distance function. In some embodiments, as compared to a more traditional Euclidean distance metric being employed, the distance function employed is equivalent to the relative distance required to travel if constrained to moving on the mesh. Based on the relative distance from the point to be interpolated to each of the control points A weighted interpolation is then created based on these relative In some embodiments, geodesic distance is employed as the distance function for the RBF interpolation, with an RBF kernel (or Gaussian kernel) applied on the resulting distance. Geodesic distance as used herein refers to the shortest distance from one point to another point on a path constrained to lie on the surface. For example, the geodesic distance between two points on a sphere (e.g., the Earth) will be a section of a circular great arc. A geodesic algorithm can be employed for calculating the geodesic distance.

In some embodiments, the RBF interpolation is performed not by computing the geodesic distance directly, but instead by computing the diffusion flow between control point positions on the surface of the mesh. If a control point is set as a diffusion source, and a diffusion process (e.g., heat) is allowed to diffuse over the surface for a finite amount of time, then the resulting temperature map on the surface will be a direct representation of a Gaussian kernel based on geodesic distance. As such, in some embodiments, the heat flow is computed directly without computing geodesic distance, leading to a faster and more numerically stable interpolation process than the aforementioned more traditional methods of RBF interpolation.

In some embodiments, computed diffusion flow is based on diffusion flow equations. In some embodiments, the diffusion flow equations comprise a standard heat diffusion, which involves setting the heat source for the mesh and determining heat diffusion based on the heat source, and a Laplacian source which converts the heat diffusion into a gradient, which can then be used to find a geodesic source. In other embodiments, the diffusion flow equations are altered to remove computing the Laplacian source and using only the diffusion source for employing the geodesic algorithm and performing the interpolation. In some embodiments, a non-linear basis is added for the RBF interpolation for faster interpolation.

FIG. 4E is an image illustrating one example of computed diffusion flows in accordance with some of the systems and methods herein. A temperature map is overlaid on top of an RBF deformed face mesh. Temperature is shown as a gradient with computed diffusion flows between user-defined control points.

After the RBF interpolation is performed, the weighted interpolations of the control points are used to generate an RBF deformed mesh. The RBF deformed mesh is a mesh resulting from the features of the neutral mesh being deformed based on the adjusted control points as modified by the user-defined control point positions.

In some embodiments, the RBF deformed mesh is further based on the system performing a spline interpolation of the initial control point positions and the user-defined control point positions, with the spline interpolation being performed prior to the RBF interpolation. One common feature of interpolation based on a representation of the Gaussian kernel of the geodesic distance is that the interpolation is global, leading to localized control points representing smooth contours not being accurately captured in the interpolation. The end result is typically artifacting present in the areas where contours are located. One way to correct for this is to employ spline interpolation to interpolate one-dimensional curves within the mesh. Certain specific parts of the mesh can be described using a spline, such as, e.g., contours around the eyelids, mouth, and other areas of the face. The spline interpolation interpolates these contours to ensure that they are smooth and realistic. In some embodiments, the spline interpolation is performed by the system pre-interpolating one or more parts of the mesh using the spline function. This involves, e.g., correcting the artifacting of radial basis by pre-interpolating parts with spline interpolation to generate smooth contours. Splines are defined along the edges of contoured regions, where the control points of the spline correspond to the control point positions residing on these edges. The displacement of the vertices (i.e., non-control points) making up these splines are interpolated, and these vertices are then added to the complete set of control point positions used to perform the RBF interpolation across the entire face. In some embodiments, the system and/or user can additionally define key facial folds for purposes of spline interpolation to ensure those folds are interpolated. The resulting RBF deformed mesh thus includes smooth contours which are accurately represented in the mesh.

FIG. 4F is an image illustrating one example of a process for providing spline interpolation in accordance with some of the systems and methods herein. In the image, contours around the eyes, including eye folds, are smoothed in a realistic way as a result of the spline interpolation. Key facial folds around the eye region are defined in order to ensure accurate smooth contours for those particular folds.

FIG. 4G is an image illustrating an additional example of a process for providing spline interpolation in accordance with some of the systems and methods herein. The face mesh on the left shows an RBF deformed mesh prior to spline interpolation. The facial folds around the eyes contain pronounced artifacting which appears as unnatural and unrealistic. Spline interpolation is performed with defined facial folds around the eye region to provide smooth contouring of the facial folds around the eyes.

At step 208, the system generates predicted wrinkle deformation data based on the RBF deformed mesh and the user-defined control points, with the predicted wrinkle deformation data being generated by one or more cascaded regressors networks, collectively comprising a “Wrinkle Deformer” process. A cascaded regressors network represents two or more regressors cascaded together. The regressors can employ linear regression, which is a supervised machine learning algorithm with a predicted output that is continuous (i.e., values are predicted within a continuous range rather than being classified into categories), and that has a constant slope. In some embodiments, the Wrinkle Deformer allows deformations to be predicted by supervised machine learning models trained on examples which demonstrate how the skin of the face stretches, compresses, and shears locally.

In some embodiments, the first regressor of a cascaded regressors network is a displacement regressor configured to predict the initial displacement of the mesh vertices and generated predicted data based on the predictions. In some embodiments, a multi-layer linear regression algorithm is employed. From the movement of the user-defined control points from the initial control points, the system interpolates all the vertex displacements in between the user-defined control points through a linear regressor. In some embodiments, the displacement regressor uses the user-defined control points and the RBF deformed mesh to predict a smooth example-based displacement field on each mesh vertex. In some embodiments, the displacement regressor is trained using a regularized linear regressor for optimal speed, although other regressors can be contemplated.

In some embodiments, the displacement regressor is trained to generate prediction data based on local encodings on different parts of the face. In some embodiments, the system receives a segmentation mask for each of the training examples used as training data. The segmentation mask is generated by segmenting the example RBF deformed mesh into a plurality of unique facial regions. In some embodiments, the segmentation is performed automatically based on detected or labeled control point regions, performed manually using a user-defined segmentation mask, or semi-automatically using some combination of both. In some embodiments, the segmentation is performed based on anatomical features of the face. For example, “fat pads” can be formed on the face where ligaments act as attachment points of the skin and form individual fat compartments. The fat pads can be used as an anatomical basis for segmenting facial regions into a segmentation mask.

FIG. 4I is an image illustrating one example of a process for providing segmented masks in accordance with some of the systems and methods herein. In the image, a segmentation mask is shown, with particular segmentation around one eyebrow region of the face.

FIG. 4J is an image illustrating an additional example of a process for providing segmented masks in accordance with some of the systems and methods herein. In the image, a segmentation mask is shown, with particular segmentation around the facial area between the upper lip and the nose.

In some embodiments, for each of the unique facial regions of the face that have been segmented, the system trains a displacement-based regressor. In some embodiments, the segmented displacement regressors are trained on the difference between the actual scanned image of the face and the RBF deformed example. While the actual scan captures the fine detailed wrinkles of the face, the RBF deformed example will represent a smooth RBF interpolation from the neutral mesh. A regressor trained on the difference between the scan and the RBF deformed example will be trained to predict the difference between smooth interpolation and detailed wrinkles.

In some embodiments, visual feedback guidance is provided within the user interface. The user adjustment or creation of user-defined control points, training of the cascaded regressors networks, or other steps of the method, the user or artist may be likely to move control point positions too far outside of the training space or some other region the control points are meant to be confined to. For example, if the expressions in the training data do not include a “happy” expression, if the user adjusts control points to move the mouth upwards, the user may still be able to produce smooth geometry using the data manipulation of the process, but meaningful wrinkles may not be produced because the regressors have not been trained on information for a “happy” expression. In some embodiments, the visual feedback guidance generates virtual markers designed to visually show the user that particular adjustments are inside of our outside of the training space or space of acceptable adjustment to produce meaningful wrinkle data. The visual markers are akin to a secondary set of control points overlaid on the mesh when the user moves control points too far. This visual feedback guidance allows for optimal wrinkle estimation.

In some embodiments, during training of the regressors, the initial control point positions are mapped onto a hyperspace defined from all or a subset of the training examples, including a number of previous RBF deformed meshes. Distances are computed between the mapped initial control point positions to the user-defined control point positions. The distances are then provided along with the visual markers within the user interface to provide visual feedback guidance as described above. In some embodiments, the visual markers are generated based on the computed distances.

FIG. 4H is an image illustrating one example of a process for providing visual feedback guidance in accordance with some of the systems and methods herein. In the image, a portion of a face mesh is shown with visual markers around the mouth region. The visual markers can appear to allow a user or artist sculpting the mesh to avoid moving control points outside of the visual markers. In this way, more accurate wrinkle data is ensured.

In some embodiments, after the displacement regressor generates predicted data for displacement of the mesh vertices, the system can generate a preview deformed mesh from geometric data obtainable from the predicted initial vertices displacement data. In some embodiments, the preview deformed mesh can be provided for display on a user interface of the client device, as a rough preview of the deformed mesh with wrinkle data. While not as accurate as a final deformed mesh would be, the preview deformed mesh is generated quickly and can provide useful data for artists in a short time frame. In some embodiments, the preview deformed data can be generated in real time or substantially real time upon the user generating user-defined control points to be sent to the system.

In some embodiments, the cascaded regressors network includes, additionally or alternatively to the displacement regressor, a deformation gradient regressor. In some embodiments, the displacement regressor is “cascaded” with (i.e., chained together with) the displacement regressor, with the deformation gradient regressor taking as input the raw predicted data and/or preview deformed mesh of the displacement regressor and refining them. In some embodiments, the deformation gradient regressor uses the preview deformed mesh to evaluate local deformation gradient tensors as part of its process in generating predicted data.

In some embodiments, the deformation gradient regressor is configured to receive and/or determine the local deformation gradient tensors around the user-defined control points and predict deformation gradient tensors on each mesh cell of the RBF deformed mesh. Each part of the face can typically be described in terms of stretch tensors, rotation tensors, and shear tensors. A deformation gradient tensor as used herein is a combination of all three tensors, without a translation component, which represents a deformation of that local patch of the skin of the face. In some embodiments, the deformation gradient tensors, once predicted, are solved and converted to the vertex displacement.

In some embodiments, this deformation gradient regression is trained using a partial least squares regressor (PLSR) for its numerical quality and stability, although many other regressors can be contemplated.

In some embodiments, the deformation gradient tensors are converted into a deformation Lie group, i.e., a set of deformation transformations in matrix space. The Lie group functions as a differentiable (i.e., locally smooth), multi-dimensional manifold of the geometric space, wherein the elements of the group are organized continuously and smoothly such that group operations are compatible with the smooth structure across arbitrarily small localized regions in the geometric space. In some embodiments, converting the deformation gradient tensors into a deformation Lie group involves taking the matrix exponent of the deformation tensors. This provides linearity and homogeneity such that the order of operations no longer matters when multiplying matrices across transformations, e.g., in applying two matrix rotations across matrices. For example, if we take a local deformation from a “happy” expression on the cheek region of the face, and then we take a deformation tensor out from an “angry” expression, then we need to combine the two deformation tensors by multiplying the matrices, which requires knowledge of the correct order of operations. If we take the matrix exponent of the two tensors, however, the order doesn't matter due to homogeneity of the properties. We can take the matrix exponents, add them together, then convert the result to the original gradient geometry by taking the logarithmic dimensions of the tensor to get back the original matrix, which is the combined matrix of the two original matrices. The resulting tensor is the average of the two tensors. In this sense, in some embodiments, the system converts the multiplicative operations into linear additive operations in order to create a simple weighted sum of the multiple tensors, which is an expression such that the deformation has some components of each individual expression and each of them are weighted equally. Linear interpretation is thus achieved in terms of scaling.

At step 210, the system provides, for display on a client device within a user interface, a final deformed mesh with wrinkles based on the predicted wrinkle deformation data. In some embodiments, the final deformed mesh is provided as part of a set of tools for artists and other users to sculpt for adaptation in various contexts and applications. In some embodiments, one application is for wrinkle transferring from a source model onto a target model without compromising the target model's anatomical structure. This allows for, e.g., skin swapping to occur such that wrinkles align on both the geometry and the texture. In some embodiments, a number of swappable facial textures can be provided for display on the client device within the user interface. The swappable facial textures includes wrinkles which are aligned with the wrinkle deformation data, the final deformed mesh, or both. The facial textures can be swapped quickly such that different faces can appear with the same wrinkles and skin folds aligned to each face. In some embodiments, Facial Action Coding System (FACS) normalization can be achieved that allows all target models to behave in a consistent and predictable manner, but without losing features and wrinkles unique to each avatar. In some embodiments, expandability can be achieved from a small set of shapes to a much larger set of shapes, with accurate deformation produced without the need for manual sculpting by artists, allowing for an automatic increase in shape network complexity. Many other applications can be contemplated.

In some embodiments, the user interface is provided by a software application hosted on the client device. The software application can be related to or facilitate, for example, 3D modeling, 3D object sculpting, deformation of 3D meshes, or any other suitable computer graphics or computer animation technique or process the methods and embodiments herein can be used in conjunction with.

FIG. 2B is a flow chart illustrating additional steps that may be performed in accordance with some embodiments. The steps are similar or identical to those of FIG. 2A, with additional optional step 212, wherein the system computes diffusion flows representing the Gaussian kernel of the geodesic distance between the initial control point positions and all other vertices in the neutral mesh, and optional step 214, wherein the system determines RBF interpolation of the initial control point positions and the user-defined control point positions based on the computed diffusion flows, as described in detail above.

FIG. 2C is a flow chart illustrating additional steps that may be performed in accordance with some embodiments. The steps are similar or identical to those of FIG. 2A, with additional optional step 216, wherein the system segments each of a number of example RBF deformed meshes into a number of unique facial regions, and optional step 218, wherein the system trains a cascaded regressors network on each unique facial region of the example RBF deformed meshes, as described in detail above.

FIG. 2D is a flow chart illustrating additional steps that may be performed in accordance with some embodiments. The steps are similar or identical to those of FIG. 2A, with additional optional steps. In optional step 220, the system predicts initial vertices displacement data using a displacement regressor as part of each of one or more cascaded regressors networks. In optional step 222, the system provides, for display on a client device within a user interface, a preview deformed mesh with wrinkles based on the predicted initial vertices displacement data. In optional step 224, the step predicts deformation gradient tensors using a deformation gradient regressor as part of each of the one or more cascaded regressors networks. These steps are described in further detail above.

### III. Exemplary User Interfaces

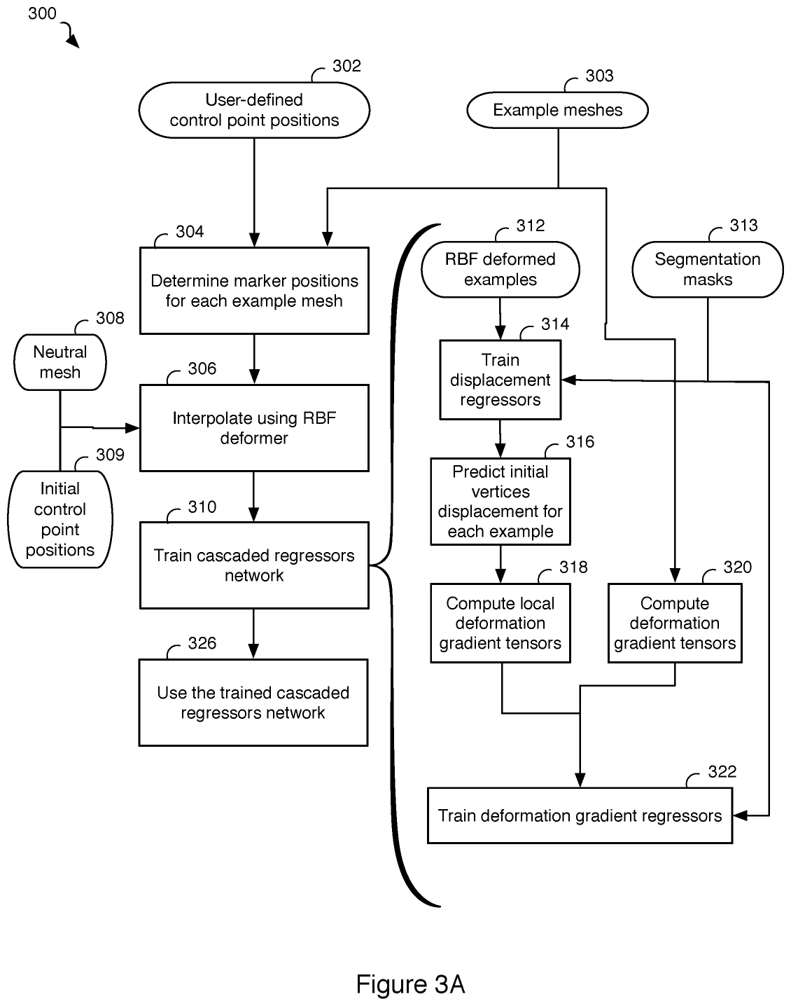

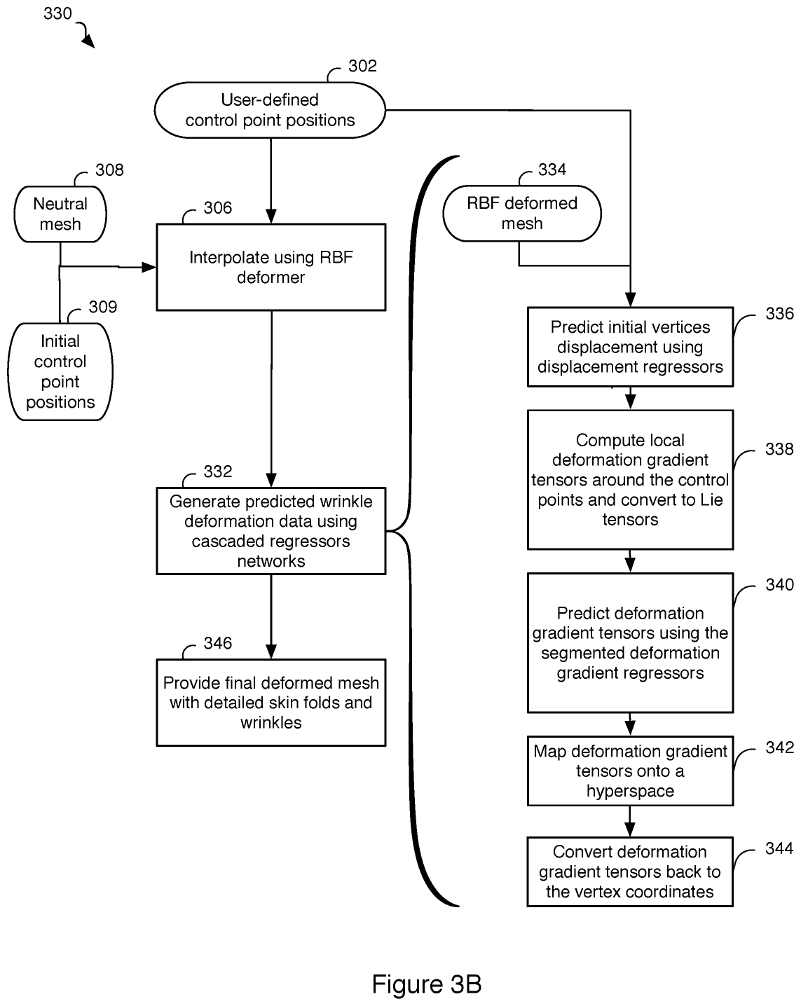

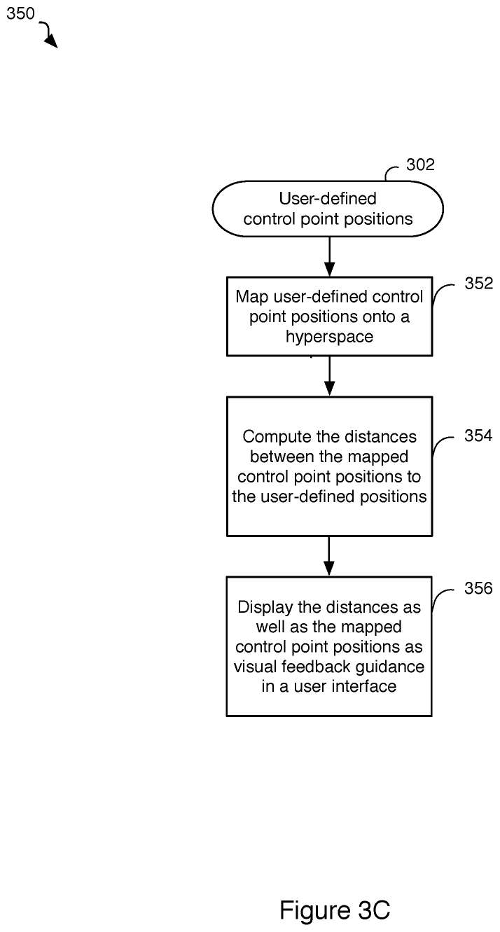

FIG. 3A is a diagram illustrating one example embodiment 300 of a process for training cascaded regressors networks in accordance with some of the systems and methods herein. At 304, a number of example meshes 303 are received, and marker positions (i.e., control point positions), are determined for each example mesh based on received user-defined control point positions 302. At 306, using a neutral mesh 308 and initial control point positions 309, the user-defined control points are interpolated with the initial control point positions using an RBF deformer.

At 310, cascaded regressors networks are trained in the following manner (blocks 312 through 324): the system receives RBF deformed examples 312 and segmentation masks 313, then at 314, trains displacement regressors based on the RBF deformed examples and the segmentation masks. At 316, initial vertices displacement for each RBF deformed example is predicted. At 318, local deformation gradient tensors are computed for the RBF deformed examples, and concurrently at 320, deformation gradient tensors are computed from the example meshes. At 322, deformation gradient regressors are trained from the computed local deformation gradient tensors of the RBF deformed examples and the deformation gradient tensors of the example meshes. Finally at 326, the trained cascaded regressors network is used to perform some of the methods and embodiments described herein.

FIG. 3B is a diagram illustrating one example embodiment 330 of a process for providing face deformation with detailed wrinkles in accordance with some of the systems and methods herein. User-defined control point positions 302, neutral mesh 308, and initial control point positions 309 are received and used at 306, where interpolation is performed on the initial control point positions and the user-defined control point positions using an RBF deformer.

At 332, predicted wrinkle deformation data is generated using cascaded regressors networks in the following manner (blocks 334 through 344): an RBF deformed mesh 334 is received, and is used with the user-defined control point positions 302 to predict initial vertices displacement using displacement regressors 336. At 338, local deformation gradient tensors are computed around the control points and converted to Lie tensors. At 340, deformation gradient tensors are predicted using the segmented deformation gradient regressors. At 342, the deformation gradient tensors are mapped onto a hyperspace of all or a subset of previous RBF deformed meshes, and then at 344 deformation gradient tensors are converted back to the original vertex coordinates.

FIG. 3C is a diagram illustrating one example embodiment of a process for providing visual feedback guidance for mesh sculpting artists in accordance with some of the systems and methods herein. At 302, user-defined control point positions are received. At 352, the user-defined control point positions are mapped onto a hyperspace of all or a subset of previous example meshes. At 354, the distances between the mapped control point positions to the user-defined positions are computed. At 356, the distances are displaced as well as the mapped control point positions to provide visual feedback guidance in a user interface for a user or artist, as described above.

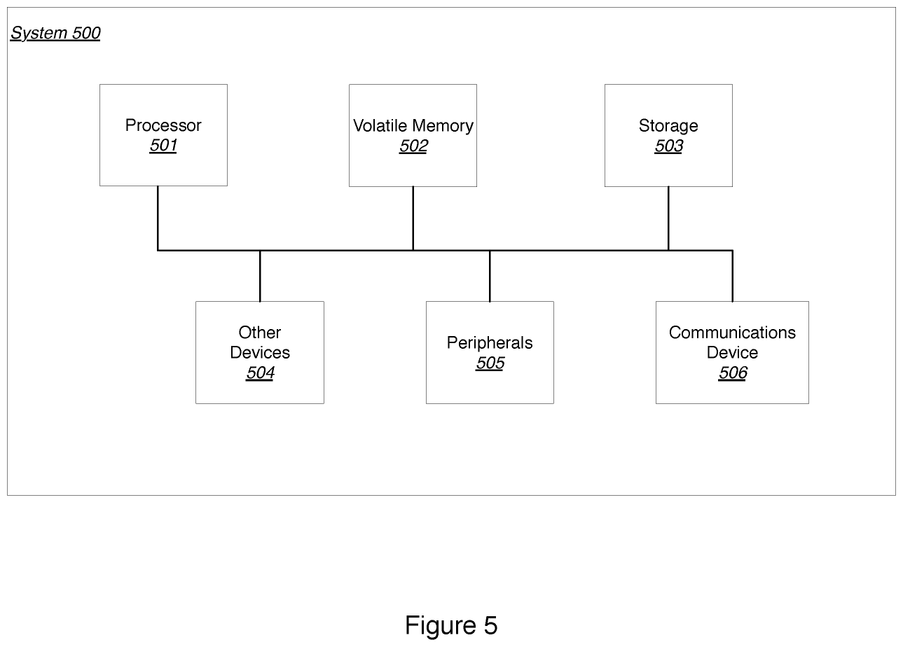

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Peripherals 505 may include removable media devices such as CD-R and DVD-R recorders/players. Communications device 506 may connect the computer 100 to an external medium. For example, communications device 506 may take the form of a network adapter that provides communications to a network. A computer 500 may also include a variety of other devices 504. The various components of the computer 500 may be connected by a connection medium 510 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for providing face mesh deformation with detailed wrinkles, the method performed by a computer system, the method comprising:
receiving a neutral mesh and a plurality of initial control point positions on the neutral mesh, wherein the neutral mesh is based on a three-dimensional scanned image of a face;
receiving a plurality of user-defined control point positions corresponding to a non-neutral facial expression;
generating a radial basis function (RBF) deformed mesh based on RBF interpolation of the initial control point positions and the user-defined control point positions;
generating predicted wrinkle deformation data based on the RBF deformed mesh and the user-defined control points, wherein the predicted wrinkle deformation data is generated by one or more cascaded regressors networks; and
providing, for display on a client device within a user interface, a final deformed mesh comprising wrinkles based on the predicted wrinkle deformation data.

2. The method of claim 1, wherein the RBF interpolation corresponds to computed diffusion flows representing the Gaussian kernel of the geodesic distance between the initial control point positions and all other vertices in the neutral mesh.

3. The method of claim 1, wherein the RBF deformed mesh is further based on a spline interpolation of the initial control point positions and the user-defined control point positions, the spline interpolation being performed prior to the RBF interpolation.

4. The method of claim 1, wherein the one or more cascaded regressors networks are trained on a plurality of training examples, wherein each of the training examples comprises an example RBF deformed mesh.

5. The method of claim 4, wherein each of the training examples further comprises a segmentation mask generated by segmenting the example RBF deformed mesh into a plurality of unique facial regions, and wherein a cascaded regressors network is trained on each unique facial region.

6. The method of claim 1, wherein the one or more cascaded regressors networks comprise a displacement regressor configured to predict initial vertices displacement data.

7. The method of claim 6, further comprising:
providing, for display on the client device within the user interface, a preview deformed mesh comprising wrinkles based on the predicted initial vertices displacement data, wherein the preview deformed mesh is provided for display in real-time or substantially real-time upon the displacement regressor predicting the initial vertices displacement data.

8. The method of claim 1, further comprising:
computing local deformation gradient tensors around the user-defined control point positions; and
converting the local deformation gradient tensors to Lie tensors,
wherein the one or more cascaded regressors networks comprise a deformation gradient regressor configured to predict deformation gradient tensors based on the Lie tensors.

9. The method of claim 8, further comprising:
converting the predicted deformation gradient tensors into vertex coordinates of the RBF deformed mesh.

10. The method of claim 1, further comprising:
mapping the initial control point positions onto a hyperspace defined from a plurality of previous RBF deformed meshes;
computing distances between the mapped initial control point positions to the user-defined control point positions; and
providing, for display on the client device within the user interface, the distances and the mapped initial control point positions as visual feedback guidance.

11. The method of claim 1, further comprising:
mapping the wrinkle deformation data onto one or more additional meshes based on three-dimensional scanned images of an additional face.

12. The method of claim 1, further comprising:
providing, for display on the client device in the user interface, one or more Facial Action Coding System (FACS) normalized meshes based on the final deformed mesh, wherein the predicted wrinkle deformation data is independent and removed from each of the one or more FACS normalized meshes.

13. The method of claim 1, further comprising:
providing, for display on the client device in the user interface, a plurality of swappable facial textures, wherein the swappable facial textures each comprise wrinkles aligned with at least one of the wrinkle deformation data and the final deformed mesh.

14. A non-transitory computer-readable medium containing instructions for providing face mesh deformation with detailed wrinkles, the instructions for execution by a computer system, the non-transitory computer-readable medium comprising:
instructions for receiving a neutral mesh and a plurality of initial control point positions on the neutral mesh, wherein the neutral mesh is based on a three-dimensional scanned image of a face;
instructions for receiving a plurality of user-defined control point positions corresponding to a non-neutral facial expression;
instructions for generating a radial basis function (RBF) deformed mesh based on RBF interpolation of the initial control point positions and the user-defined control point positions;
instructions for generating predicted wrinkle deformation data based on the RBF deformed mesh and the user-defined control points, wherein the predicted wrinkle deformation data is generated by one or more cascaded regressors networks; and
instructions for providing, for display on a client device within a user interface, a final deformed mesh comprising wrinkles based on the predicted wrinkle deformation data.

15. The non-transitory computer-readable medium of claim 14, wherein the RBF interpolation corresponds to computed diffusion flows representing the Gaussian kernel of the geodesic distance between the initial control point positions and all other vertices in the neutral mesh.

16. The non-transitory computer-readable medium of claim 14, wherein the one or more cascaded regressors networks are trained on a plurality of training examples, wherein each of the training examples comprises an example RBF deformed mesh.

17. The non-transitory computer-readable medium of claim 14, wherein each of the training examples further comprises a segmentation mask generated by segmenting the example RBF deformed mesh into a plurality of unique facial regions, and wherein a cascaded regressors network is trained on each unique facial region.

18. The non-transitory computer-readable medium of claim 14, wherein the one or more cascaded regressors networks comprise a displacement regressor configured to predict initial vertices displacement data.

19. The non-transitory computer-readable medium of claim 18, further comprising:
instructions for providing, for display on the client device within the user interface, a preview deformed mesh comprising wrinkles based on the predicted initial vertices displacement data, wherein the preview deformed mesh is provided for display in real-time or substantially real-time upon the displacement regressor predicting the initial vertices displacement data.

20. The non-transitory computer-readable medium of claim 14, further comprising:
instructions for computing local deformation gradient tensors around the user-defined control point positions; and
instructions for converting the local deformation gradient tensors to Lie tensors,
wherein the one or more cascaded regressors networks comprise a deformation gradient regressor configured to predict deformation gradient tensors based on the Lie tensors.
